(19) United States
(12) Patent Application Publication
(10) Pub. No.: US 2013/0189652 A1
(43) Pub. Date: Jul. 25, 2013

(54) METHOD OF LINGUISTIC PROFILING

(71) Applicant: Annu Marttila, Helsinki (FI)

(72) Inventor: Annu Marttila, Helsinki (FI)

(73) Assignee: PRONOUNCER EUROPE OY, Helsinki (FI)

(21) Appl. No.: 13/878,284

(22) PCT Filed: Oct. 12, 2011
(86) PCT No.: PCT/FI11/50882

§ 371 Date: Apr. 8, 2013

(30) Foreign Application Priority Data
Oct. 12, 2010 (FI) 20106048

(51) Int. Cl. G09B 5/00

(52) U.S. Cl. CPC G09B 5/00
USPC 434/156

(57) ABSTRACT

In order to define or measure the language proficiency of a person, particularly the degree of flawlessness in the pronunciation, and/or to find out the linguistic background and identity of a person, the person's speech is compared with a selected reference language. This is achieved by applying autocorrelation and/or pattern recognition and/or signal processing and/or other corresponding methods for identifying and registering such sound elements and features that are typical of the reference language and occur repeatedly in the reference language speech sample. On the basis of the obtained linguistic profile of the reference language, corresponding sound elements and features are searched in the speech of the person, and there is calculated how many of the sound elements and features of the reference language linguistic profile the person substitutes with such sound elements or features that deviate from the reference language, and the substitute sound elements and features are defined.

### FIELD OF INVENTION

The invention relates to a method where the speech of a person under investigation is compared with a speech sample of a selected reference language for defining or measuring the language proficiency of said person, particularly for defining the degree of flawlessness in his/her pronunciation and/or for investigating the person's own language background and identity.

### PRIOR ART

Each language is spoken in many different ways. The pronunciation and mode of speaking a language are principally defined on the basis of the language and mode of speaking that the speaker has learned to use in his/her early childhood, generally according to his/her mother tongue. At the same time they are defined according to the location or region where the speaker has spent his/her early childhood. Moving to another language or dialect area affects the pronunciation and mode of speaking of a person, sometimes fairly slowly, but in the case of a young person often fairly rapidly. The style of speech and pronunciation are also affected by the speaker's social status and level of education.

The human language skills are extremely versatile. Pronunciation is an essential dimension of language proficiency. It affects, among others, the intelligibility of speech, its expressive characteristics, impressiveness, the speaker's communicative skills, personal image, capability of fulfilling duties at work as well as his/her success. One of the main objectives in language training is to teach correct pronunciation. It would become essentially easier if mispronunciations could be measured and analyzed, so that each student could even alone practice how to correct pronunciation errors and measure his/her progress without always having a teacher present. On the other hand, for example in job interviews it would be important to be able to numerically measure each applicant's degree of flawlessness in pronunciation in those languages that are necessary for dealing with the appropriate duties, and to compare it with recommended values and the values obtained from other applicants. A suitable method for these purposes has been lacking in the prior art.

For example an immigration authority or a police may need information as for the mother tongue of the person under investigation, especially if said person attempts to disguise his/her real identity by speaking another language or dialect. Also in crime investigation it is important to find out for instance whose voices are heard in a telephone conversation or other sound sample, and exclude suspects whose voices are not heard. It may also be necessary in different customer service points to find out what is the language used by the customer, in order to be able to serve him/her in the appropriate language.

### DESCRIPTION OF INVENTION

In the above described situations where the aim is to define the language or identity of the speaker, or to measure the degree of flawlessness in pronunciation, there are no rapid and reliable registering, comparison or measuring methods. The object of the invention is to create a method by means of which it is possible in a relatively simple way to find out the spoken language and the degree of flawlessness in its pronunciation, and to solve various problems related to the origin of the language used by a person under investigation, as well as to the identity of said person. The object of the invention is achieved by a method according to claim 1, and by a device according to claim 10.

Human speech is composed of certain sound elements, phonemes, other pronunciation characteristics and linguistic features. According to a generally applied standard of phonetics, typically 30-50 different sound elements as well as other linguistic features are distinguished in individual languages. Because the quantity of said elements and features is relatively low, they are repeated even in a fairly short sound sample. Generally said repeated sound elements and linguistic features form the linguistic profile of a language.

The method according to the invention is particularly based on that there are first defined the linguistic profiles of both the language under investigation and the reference language. In order to define the linguistic profile of the reference language from an electronically recorded speech sample of the reference language, there are identified and registered such sound elements and linguistic features of the reference language that are repeated in said audio sample, by using autocorrelation and/or pattern recognition and/or signal processing methods or other necessary methods. By means of a suitable computer program, these sound elements and linguistic features of the reference language are searched from an electronically recorded speech sample of the person under investigation. At the same time it is possible to define which sound elements or linguistic features of the linguistic profile of the reference language are absent from the speech sample of the person under investigation, and which features the person substitutes by a sound element or linguistic feature deviating from the reference language, and, when necessary, to define what are these substitute sound elements and linguistic features. The number of detected deviations can also be electronically calculated. Simultaneously the program controlling the process can register whether the person under investigation uses any such sound elements or linguistic features that do not occur in the reference language sample, and probably have their origins in the speaker's own mother tongue. On the basis of the obtained results, the degree of flawlessness in the language pronunciation can be measured, and the person and/or the respective linguistic background can be identified.

The accuracy of the method according to the invention can be essentially increased in that both when defining the linguistic profile of the reference language and when analyzing the speech sample of the person under investigation, special attention is paid to the phonetical, phonological, morphophonological, prosodic and language typological sound elements, as well as to other linguistic features.

The method according to the invention can also be applied so that there is defined the significance and/or nature of the differences in those sound elements and linguistic features in the speech sample of the person under investigation that deviate from the reference language. This is important particularly when applying the invention in teaching and learning a correct, flawless pronunciation of a language.

When so desired, the method according to the invention can be developed to analyze the mispronunciations of a person practicing pronunciation with respect to phonetical, phonological, morphophonological and prosodic sound elements, as well as to other linguistic features, and preferably also to register all mispronunciations and the absolute and relative numbers of their repeated occurrences. Moreover, the method can be applied to give recommendations as for which mispronunciations the person in question should pay attention to in order to correct them primarily, secondarily and so on. These applications speed up the learning of the pronunciation of a spoken language.

The development of a method according to the invention up to a level that improves the learning of a language as described above requires data that enables an analysis of sound elements, registering of mispronunciations and calculating the number of their occurrences, as well as the structuring of an individual recommendation for a person learning the correct, impeccable pronunciation and the designing of a framework to that effect. This kind of data can be for example an instruction fed to a computer, which instruction detects the desired sound elements by applying said recognition methods and analyzes and registers them. The process can be controlled so that the number of desired sound elements is detected, and that the nature of the differences between them and the reference language is then defined. On the basis of the obtained results, the program can draw the student's attention to those sound elements or linguistic features that he/she should particularly practice.

The method according to the invention can also be applied so that in order to find out the own language of the person under investigation, the speech sample or linguistic profile of said person is compared with the speech samples or linguistic profiles of several reference languages, and that on the basis of the detected differences, it is judged from which reference language the speech sample or linguistic profile of the person under investigation differs least with respect to the pronunciation profile. This facilitates the application of the invention in finding out the original residential area, social class and/or identity of the person under investigation.

The method according to the invention can also be applied so that when the person under investigation is suspected of giving false information as regards his/her identity, the speech sample of the person under investigation is compared with several reference samples that are typical of the identity claimed by the person under investigation, in which case it is detected whether the speech sample of said person deviates from said reference samples to that extent that the alleged identity is possibly false, or at least that said person cannot be the person he/she claims to be. This is an important aspect when applying the invention to defining the identity of a person under investigation.

When the aim is to find out the home region and/or the social background of a person under investigation, the invention can be applied by comparing the speech sample or linguistic profile of said person with the reference languages of various different social classes of known language areas, or with the linguistic profiles of said reference languages, and by detecting from which speech sample or linguistic profile of the reference language of a geometric and/or social environment or class the speech sample, or its linguistic profile, of the person under investigation deviates less. This facilitates the application of the invention in finding out the original residential area, social class and/or identity of the person under investigation.

A device according to claim 10 can advantageously be used for applying the method according to the invention. The device includes a memory unit suitable for electronically recording speech samples of reference languages and of languages under investigation, and computer programs enabling the use of autocorrelation and/or pattern recognition and/or signal processing methods and other necessary methods. The linguistic profiling of the reference languages can be carried out by said methods, and the results can be compared with the sound samples or language profiles of the languages under investigation. The device also includes programs for registering the differences detected in the comparison process, and for interpreting and illustrating the results, as well as for comparing them with other respective results.

A memory unit suited for electronic recording is for example a digital memory with a sufficiently large memory capacity, such as many hundreds of gigabytes, or when necessary many terabytes, which digital memory can be used in computer applications. The device also includes computer programs for registering and illustrating the differences detected in the comparison process, and for giving a recommendation in order to increase the degree of flawlessness in pronunciation. By combining existing programs, and when necessary by programming new algorithms, it is possible to register and illustrate the differences detected in the mutual comparison between a reference sample or linguistic profile and the sample or linguistic profile under investigation. The program can be developed so that it analyzes the most significant pronunciation and linguistic deviations and gives a recommendation as regards the priority order of the target practices and corresponding means of study, as well as an optimal timing and sequencing of training sessions, and of the time required for the task.

### BRIEF DESCRIPTION OF DRAWINGS

The invention is described in more detail below, with reference to the appended drawings, where

FIG. 1 is a flow diagram illustrating a method according to the invention, and

FIG. 2 illustrates a device for realizing the method according to the invention.

### DESCRIPTION OF PREFERRED EMBODIMENTS OF THE INVENTION

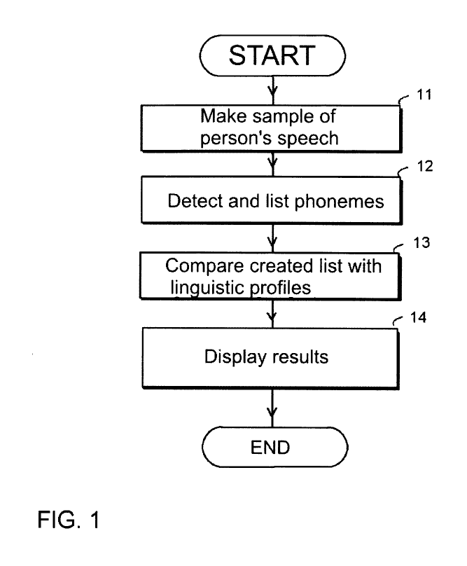

A method according to a preferred embodiment of the invention is illustrated as a flow diagram in FIG. 1. The method can be used for example for detecting the possible mother tongue of a person. In step 11 of the method, there is first made a sample of the person's speech. It can be either an auditory perception or a recorded sample. In step 12, there is composed a list of the phonemes contained in the sample. If the list is composed manually, the phonemes are those that cannot be contained in the speech of the person. In that case the process is an exclusionary recognition process, where the perceiver lists that familiar phoneme that he/she has heard to be mispronounced by the person under investigation. With automatic speech recognition, the list includes phonemes detected in speech, i.e. the process is an inclusionary recognition process.

In step 13, the list of phonemes included in the person's speech sample is compared with a phoneme list formed by each language profile. The comparison is carried out for example language by language, so that all of the phonemes included in the person's list are dealt with. A language is excluded, if

a) an exclusionary phoneme contained in the person's list is included in the profile of said language, or if

b) a phoneme contained in the person's list is not included in the profile of said language.

In step 14, there are displayed those remaining languages that are possible mother tongues of said person.

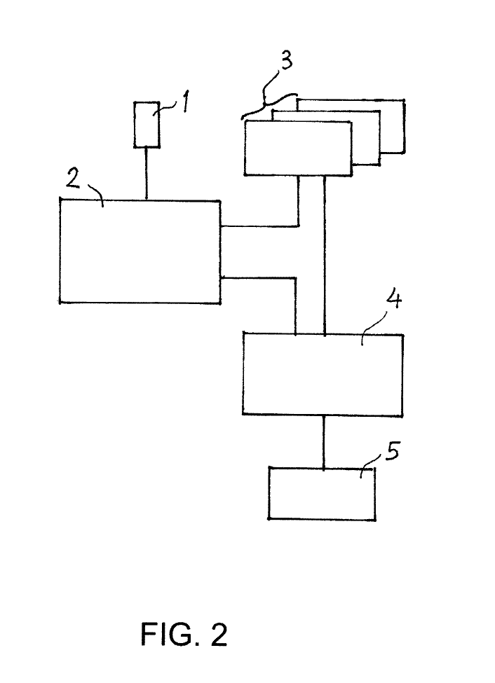

The structure in principle of a preferred embodiment of a device designed for applying the method according to the invention is described in the appended FIG. 2. Number 1 refers to an input unit that can be for instance a microphone, a sound reproducer or a receiver that can be connected to the Internet. The input unit 1 is connected to a memory unit 2, in which the signals received through the input unit are recorded. The signals recorded in the memory unit 2 can be processed in different ways by means of one or several computer programs contained in a program unit 3. Thus, on the basis of sound samples contained in the memory unit 2, it is possible to compile linguistic profiles of the material under examination. Other material of the reference languages is also recorded in the memory unit 2 or the program unit 3, for instance linguistic profiles and other linguistic features of the reference languages.

The program unit 3 is connected to a reference unit 4, which can also receive signals directly from the memory unit 2. Generally the operation of the reference unit 4 is, however, controlled directly from the program unit 3. The reference unit 4 carries out the comparison between the speech sample and the reference language, in most cases by using autocorrelation and/or pattern recognition and/or signal processing. The results of the comparison are transferred to a display/output unit 5, where the result can be represented in a linguistic, phonetic, graphic, analog or other suitable form. The output may also include instructions and recommendations for the users of the device. The device illustrated in the drawing may be included for example in a portable computer or mobile phone. It is pointed out that the above described program unit and reference unit can also be realized in the form of programs carried out by a computer processor, for example.

We shall below explain a few terms and concepts that are important for the invention, as well as details of a few embodiments.

The concept ‘speech sample in electronic form’ refers, for instance, to a sound signal converted to an electronic signal by a microphone or a recording device. A ‘speech sample’ refers, for instance, to the recorded speech of a person speaking a reference language, or of a person under investigation. A speech sample in electronic form can be analyzed for example by electrically calculating the number of sound elements represented in the sample. Here the term ‘electric calculation’ refers to digitally performing the calculations of a computer program.

Unless otherwise stated, the concept ‘language’ refers to a language corresponding to dictionary meanings, i.e. a national language or an official language, as well as to language variations, spoken languages, and languages of different social groups, such as the language spoken at home, youth language, different dialects and slangs.

When defining the significance and/or nature of the deviating sound elements and linguistic differences occurring in the speech sample of a person under investigation when compared to a reference language, special attention is paid to the following aspects. One parameter that can be freely chosen by the program controlling the application of the method is accuracy in distinguishing deviations. By altering the values of this parameter, it is possible to define at which distinguishing accuracy each deviation is automatically detected. If the selected distinguishing accuracy is low, only significant deviations are registered. With a higher distinguishing accuracy, there are also registered deviations with a smaller significance. By altering the distinguishing accuracy, it is possible to suitably define how significant deviations should be registered, and what is the limit for deviations that are too small for being taken into account.

A linguistic profile is composed of such phonetic, phonological, morphophonological and prosodic sound elements and phonemes as well as language typological features that are repeated for example in speech or in a speech sample. The process of defining a linguistic profile is called linguistic profiling.

In the process of defining a linguistic profile, there is used autocorrelation and/or pattern recognition and/or signal processing and/or other corresponding methods. In general statistics and signal processing, autocorrelation is a mathematical tool that describes the mutual dependence between observations within a time sequence as a function of the time difference between said observations. Autocorrelation may occur in a time sequence when the sequence is not completely random, but the new observations are dependent on earlier observations. Among other things, an autocorrelation method registers which features are repeated in a signal, for instance in sound converted to an electronic signal, and how clearly they are repeated.

By using pattern recognition, it is possible to develop systems that identify models or patterns from data. Among the applications of pattern recognition, let us point out for example automatic recording of speech as text, and human face recognition. By means of pattern recognition methods, any possible multiform entity can be compared with corresponding models, and there can be concluded which model, for example a word, it best resembles. A known application of pattern recognition is to compare the sound of an underwater vessel with earlier registered sounds of different submarine types in order to find out which of them said sound pattern best resembles.

Signal processing includes, among others, conversion of analog signals to digital, and vice versa. By using signal processing methods, it is possible to create nearly any kind of signals, and to subject nearly any kind of signals to various different calculations, mathematical and other conversions and/or analyses, for instance to submit a signal for first or second order differentiation or integration, or to many different types of frequency analyses. An important class of signals is formed by audio signals, i.e. sound signals. By applying the methods of signal analysis, it is for example possible to recognize and separate elements or features repeated in the signal, as well as to compare different signals and analyze their common features.

The nature of phonemic differences can be detected by comparing the characteristics and nature of the deviations in the sound sample with the characteristics and nature of the model deviations included in the program. For instance, it is possible to register interesting special features and look for them in the sample under examination.

Among typical sound elements and linguistic features of a language let us point out for example phonemes, morphemes, lexical items, prosodic and language typological sound elements and linguistic features, as well as any sound elements and linguistic features repeated in an acoustic or electronic sound sample.

When studying what are the sound elements and linguistic features deviating from the reference language, there are defined those phonetical, phonological, morphophonological and prosodic sound elements and language typological features by with the person under investigation substitutes corresponding phonetical, phonological, morphophonological and prosodic phonemes or sound elements and language typological features of the reference language. In this process, there is used autocorrelation and/or pattern recognition and/or signal processing.

When studying the significance and nature of the differences with respect to the sound elements and linguistic features of the speech sample deviating from those of the reference language, the equivalents of the sound elements and linguistic features of the reference language are searched for in the linguistic profile of the language under examination. Now the computer program may reject an equivalence that deviates either very little or very much from the specific sound element or linguistic feature in the linguistic profile of the reference language. The issue of how big this difference must be that the computer rejects it and does not identify it as equal to the one included in the reference language is here called significance in the differences of deviant sound elements. The tolerance of this comparison process is one of the many parameters to be defined for the computer program. On the other hand, the nature of the differences in deviant sound elements refers to the form of a sound element represented in electronic form, for example to how smoothly or unevenly the vowel in a diphthong glides from the first component to the second component of the diphthong.

When studying the deviations between a reference language and the language under investigation in order to define the identity of the person under investigation in a case where said person is suspected of giving false information of identity, both the quantity and quality of the deviations can be registered. Quantity can be measured in the same way as quality, i.e. by numeral values in the degree of flawlessness in pronunciation. For instance, if the degree of flawlessness in pronunciation is 80%, the alleged identity can hardly be claimed false without reservation. If said degree is 40%, it is fairly reliable to consider the alleged identity to be false. The selection of the percentage scale where said 40% and 80% belong forms part of the selection of the parameter relating to the reliability of conclusion, and of the standardization of the empirical interpretation of said parameter.

The higher the degree of flawlessness in the speech under examination or the linguistic profile thereof is, the less the examined speech sample or its linguistic profile deviates from the speech sample or linguistic profile of the reference language. The same applies to any two speeches, speech samples or linguistic profiles. When necessary, either of them can be considered as the reference language.

A phoneme is a speech sound that at least in one language is a unit for distinguishing meanings and that can be expressed by a letter. Among the phonemes of the Finnish language, there are for example [i] and [u], which render a different meaning for words that are otherwise identical, such as kilo (kilogram) and kulo (forest fire). The number of existing phonemes is limited, and each language includes part of these. Hence, all phonemes do not occur in all languages. Phonology studies how different phonemes are used in different languages. A phonetical and phonological sound element refers to a phoneme or to a phoneme sequence.

A morpheme is the smallest meaningful unit in language. A morpheme can be a word or a case ending. One word may include one or several morphemes. For instance the Finnish word auto is a morpheme, but the word autoissamme includes four different morphemes: auto-i-ssa-mme, each of which has its own individual meaning. Morphology studies how different languages use morphemes for forming words. Between languages, there are differences for instance in that some join morphemes into sequences, such as the Finnish autoissamme, whereas others write the morphemes separately, as the English in our cars. Morphemes are linguistic features. Morphophonology studies how phonemes vary within morphemes. In Finnish, this kind of variation occurs because of vowel harmony, as can be observed in the inessive case endings in the words koulussa (at school) and metässä (in the forest). These are examples of morphophonological sound elements.

Prosody and prosodic include the stress and timing of words, the length of word elements, tone and pitch of voice, melody and intonation as well as any intensifying of communication or complementing of significance that is carried out by means of said language features. Prosodic features vary in the languages of the world. There is no prosodic feature that would occur in all languages of the world. For example, in Finnish intonation does not carry meaning, but in French a declaratory sentence can be converted to interrogative by raising the intonation towards the end of the sentence. Prosodic features are linguistic features.

Linguistic mechanisms are universal, but as for the realization thereof, there are differences between languages. For instance, among the possible basic word orders, i.e. orders between the subject (S), object (O) and predicate (V), there are six different alternatives: OSV, OVS, SVO, SOV, VSO, VOS. The languages of the world are divided into these six classes. All such linguistic features that are connected to language, and where rules and regularities can be found, are significant with respect to the present invention.

1. A method where, in order to measure or define the language proficiency of a person under investigation, particularly the degree of flawlessness in his/her pronunciation and/or in order to investigate the person's own language background and identity, the speech of the person under investigation is compared with a speech sample of a selected reference language, characterized in that from an electronic speech sample of a reference language, there are identified and registered, by using autocorrelation and/or pattern recognition and/or signal processing or some other corresponding method, such sound elements and linguistic features that are repeatedly represented in the reference language speech sample and are typical of said language, and on the basis of the obtained linguistic profile of the reference language, corresponding sound elements and/or linguistic features are searched from an electronically recorded speech sample of the person under investigation, and/or there is defined which of the sound elements or linguistic features of the linguistic profile of the reference language the person under investigation substitutes with such sound elements or linguistic features that deviate from the reference language, and/or there is defined what these substitute sound elements and linguistic features are.

2. A method according to claim 1, characterized in that in the speech sample of the reference language and the person under investigation, special attention is paid to the phonetical, phonological, morphophonological and prosodic sound elements, as well as to other linguistic features.

3. A method according to claim 1 2, characterized in that there is defined the significance and/or nature of the differences in the sound elements and linguistic features occurring in the speech sample of a person under investigation and deviating from the reference language.

4. A method according to claim 1, characterized in that in order to find out the own language of the person under investigation, the speech sample of said person is compared with the speech samples of several reference languages, and that on the basis of the detected differences, it is judged from which reference language the speech sample of the person under investigation differs least with respect to the pronunciation profile.

5. A method according to claim 1, characterized in that in order to find out the identity of the person under investigation in a case where said person is suspected of giving false information as for his/her identity, the speech sample of the person under investigation is compared with several reference samples obtained from a language or dialect area that is typical of the identity claimed by the person under investigation, in which case it is judged whether the speech sample of the person under investigation deviates from said reference samples to that extent that the claimed identity is probably false, or that the person cannot be who he/she claims to be.

6. A method according to claim 1, characterized in that in order to find out the home region and/or social background of the person under investigation, the speech sample of said person is compared with the reference languages of different language areas and social classes, and on the basis of said comparison, it is judged from which reference language sample of which geographical and/or social environment or social class the speech sample of the person under investigation deviates least.

7. A method according to claim 1, characterized in that when applying the invention to teaching and learning a correct, flawless pronunciation, the program controlling the process is complemented with data by means of which the program is capable of distinguishing the mispronunciations of the person training pronunciation as regards phonetical, phonological, morphophonological and prosodic sound elements, as well as other linguistic features.

8. A method according to claim 7, characterized in that the program controlling the process is complemented with data by means of which the program is capable of registering mispronunciations and the number of their repeated occurrences.

9. A method according to claim 7, characterized in that the program controlling the process is complemented with data by means of which the program is capable of giving recommendations as to which mispronunciations and their correction the person using the program should pay primary attention to, to which secondary attention, and so on.

10. A device for applying the method according to claim 1, characterized in that said device includes a memory unit suitable for electronic recording of speech samples of one or several reference languages and of the language under investigation, as well as one or several computer programs that are arranged to enable the use of autocorrelation and/or pattern recognition and/or signal processing methods and other necessary methods for the linguistic profiling of one or several reference languages, and the comparison of one or several reference languages with the speech sample or linguistic profile of the language under investigation, and programs for registering and illustrating the comparison results and/or for comparing them with other corresponding results.

11. A method according to claim 2, characterized in that there is defined the significance and/or nature of the differences in the sound elements and linguistic features occurring in the speech sample of a person under investigation and deviating from the reference language.

12. A method according to claim 2, characterized in that in order to find out the own language of the person under investigation, the speech sample of said person is compared with the speech samples of several reference languages, and that on the basis of the detected differences, it is judged from which reference language the speech sample of the person under investigation differs least with respect to the pronunciation profile.

13. A method according to claim 3, characterized in that in order to find out the own language of the person under investigation, the speech sample of said person is compared with the speech samples of several reference languages, and that on the basis of the detected differences, it is judged from which reference language the speech sample of the person under investigation differs least with respect to the pronunciation profile.

14. A method according to claim 2, characterized in that in order to find out the identity of the person under investigation in a case where said person is suspected of giving false information as for his/her identity, the speech sample of the person under investigation is compared with several reference samples obtained from a language or dialect area that is typical of the identity claimed by the person under investigation, in which case it is judged whether the speech sample of the person under investigation deviates from said reference samples to that extent that the claimed identity is probably false, or that the person cannot be who he/she claims to be.

15. A method according to claim 2, characterized in that in order to find out the home region and/or social background of the person under investigation, the speech sample of said person is compared with the reference languages of different language areas and social classes, and on the basis of said comparison, it is judged from which reference language sample of which geographical and/or social environment or social class the speech sample of the person under investigation deviates least.

16. A method according to claim 2, characterized in that when applying the invention to teaching and learning a correct, flawless pronunciation, the program controlling the process is complemented with data by means of which the program is capable of distinguishing the mispronunciations of the person training pronunciation as regards phonetical, phonological, morphophonological and prosodic sound elements, as well as other linguistic features.

17. A method according to claim 8, characterized in that the program controlling the process is complemented with data by means of which the program is capable of giving recommendations as to which mispronunciations and their correction the person using the program should pay primary attention to, to which secondary attention, and so on.
